(19) United States
(12) Patent Application Publication
(10) Pub. No.: US 2009/0233794 A1
(43) Pub. Date: Sep. 17, 2009

(54) Sheet-Like Transfer Medium for Transferring Images With Sublimating Inks

(76) Inventor: Tito Trevisan, Verona (IT)

Correspondence Address: Modiano & Associati, Via Meravigli, 16, Milan, 20123, IT

(21) Appl. No.: 11/989,114

(22) PCT Filed: Jul. 13, 2006
(86) PCT No.: PCT/EP2006/006870

§ 371 Date: Jan. 22, 2008

(30) Foreign Application Priority Data
Jul. 29, 2005 (IT) VR2005A000095

(51) Int. Cl. B41M 5/035

(52) U.S. Cl. 503/227

(57) ABSTRACT

A sheet-like transfer medium for transferring images with sublimating inks, comprising a backing layer and an active layer; the active layer faces an object to be treated and is adapted to form a plurality of air drainage channels in order to allow to maintain, in an interspace between the sheet-like medium and the object to be treated, a substantially uniform pressure which is lower than a pressure that acts on an outer side of the sheet-like medium; at least one layer comprising sublimating inks is interposed between the backing layer and the active layer; the active layer is also at least partially permeable to the gaseous phase of the sublimating inks.

The present invention relates to a sheet-like transfer medium for transferring images with sublimating inks.

### BACKGROUND OF THE INVENTION

As is known, printing processes with sublimating inks consist in transferring a graphical representation imprinted by means of sublimating inks onto a sheet-like medium, known as transfer medium, to the surface of an object to be decorated, known as imprintable material.

In order to achieve a satisfactory transfer of the inks during their sublimation, such sheet-like transfer medium must be perfectly in contact with the imprintable surface of the object to be decorated.

Sheet-like transfer media made of paper-like material are already known, but they are unsuitable if the surface of the object to be decorated, instead of being flat, is uneven or contoured, since they tend to form creases which cause considerable defects in the transferred image.

One solution used to try to solve this problem entails using a sheet-like transfer medium made of elastoplastic material. However, this solution is not entirely satisfactory, since during the transfer of the ink there is great difficulty in draining the gas, consequently forming bubbles and reducing the quality of the final print.

Another solution has been disclosed in Italian patent no. 1,314,414 by the same Applicant, and consists of a sheet-like transfer medium formed by a backing layer, made of PVOH, on one face whereof there is a layer of microfibers, made of a material known by the trade name Rayon, onto which a layer of sublimating ink is distributed. In particular, the microfibers are applied by flocking on the backing layer by interposing a layer of adhesive material constituted by PVOH.

The presence of the layer of microfibers has the advantage of facilitating escape of the air when vacuum is produced between the transfer medium and the body designed to receive the image.

This type of transfer medium, though being capable of adapting excellently even to considerably irregular surfaces, has not proved to be fully satisfactory in all possible applications, since the degree of definition of the transferred images depends highly on the density of the microfibers.

### SUMMARY OF THE INVENTION

The aim of the present invention is to eliminate the drawbacks noted above by providing a sheet-like transfer medium for transferring images with sublimating inks that allows a remarkable development in the possibilities of application of this decorative technique.

Within this aim, an object of the present invention is to provide a sheet-like transfer medium for transferring images with sublimating inks that is capable of adapting easily to any type of surface to be decorated.

Another object of the present invention is to provide a sheet-like transfer medium for transferring images with sublimating inks that allows to achieve excellent image quality with high degree of definition.

Still another important object is to provide a sheet-like transfer medium for transferring images with sublimating inks that is constructively simple so as to be competitive also from a merely economical standpoint.

This aim and these and other objects, which will become better apparent hereinafter, are achieved by a sheet-like transfer medium for transferring images with sublimating inks, characterized in that it comprises a backing layer and an active layer, said active layer being provided so as to face the object to be treated and being adapted to form a plurality of air drainage channels in order to allow to maintain, in the interspace between the sheet-like medium and the object to be treated, a substantially uniform pressure which is lower than the pressure that acts on the outer side of the sheet-like medium, at least one layer comprising sublimating inks being interposed between said backing layer and said active layer, said active layer being at least partially permeable to the gaseous phase of said sublimating inks.

### BRIEF DESCRIPTION OF THE DRAWINGS

Further characteristics and advantages of the invention will become better apparent from the description of some preferred but not exclusive embodiments of a sheet-like transfer medium for transferring images with sublimating inks according to the invention, illustrated by way of non-limiting example in the accompanying drawings, wherein:

FIG. 1 is a schematic perspective view of the sheet-like medium according to the invention;

FIG. 2 is an enlarged-scale sectional view of an embodiment of the medium according to the invention, taken along its thickness;

FIG. 3 is a schematic sectional view of the use of the medium according to the invention.

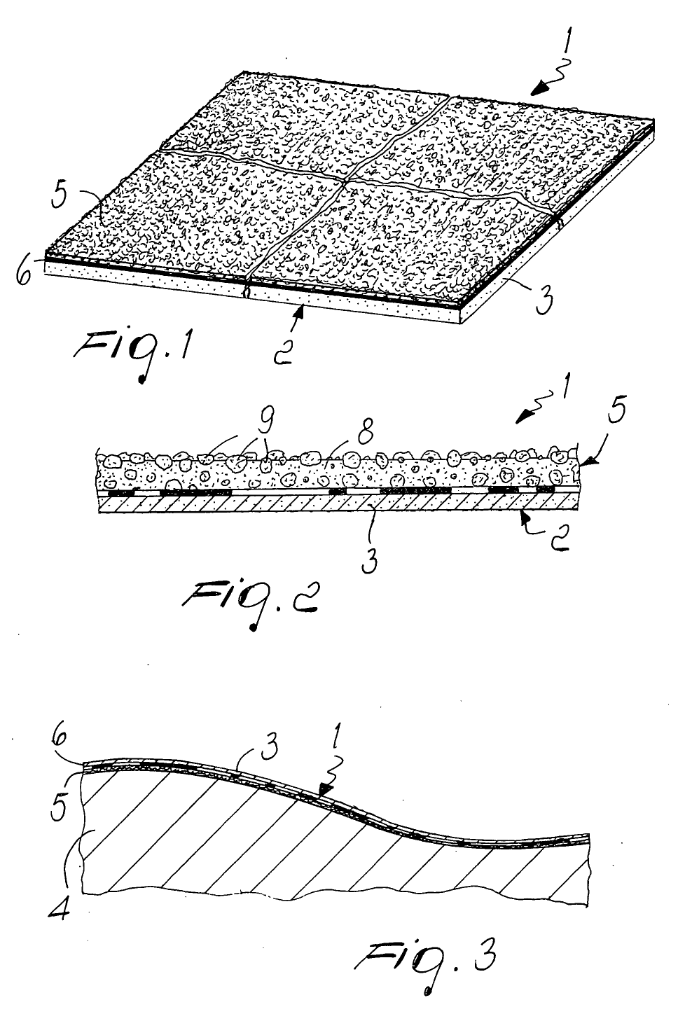

### DESCRIPTION OF THE PREFERRED EMBODIMENTS

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

With reference to the figures, the sheet-like transfer medium for transferring images with sublimating inks, according to the invention, generally designated by the reference numeral 1, is provided with a backing layer 2, which comprises advantageously a film 3 made of substantially thermoplastic material, such as for example amorphous PET (a-PET) by thermoformation or PA, so as to be elastically flexible at the operating temperatures reached during the image transfer process and therefore be able to adhere to the most disparate shapes of an object 4 to be treated.

As an alternative, the backing layer 2 can also have a substantially rigid structure and therefore be formed conveniently by a sheet-like element made of paper-like material or by a biaxially-oriented polyester film, such as for example the material known by the trade name Mylar, manufactured by the DuPont company.

Moreover, the sheet-like medium 1 has one face formed by an active layer 5, which is provided so as to face the object 4 to be treated.

As explained in greater detail hereinafter, the active layer 5 has the important function of allowing, when vacuum is produced, the complete evacuation of the air between the sheet-like medium 1 and the body to be decorated, so as to provide perfect adaptation of the sheet-like medium 1 even to highly irregular surfaces, ensuring uniform transfer of the image onto the entire surface of the object 4 to be treated.

A peculiar aspect of the invention resides in that it provides, between the backing layer 2 and the active layer 5, at least one layer 6 obtained by means of sublimating inks.

It should be noted that the active layer 5 is structured so as to be at least partially permeable to the gaseous phase of the sublimating inks of the layer 6.

Advantageously, the backing layer 2 is instead substantially impermeable to sublimating inks in the gaseous phase, i.e. it practically absorbs no ink quantity that may be significant for the described transfer process.

In a possible embodiment, the active layer 5 can be conveniently formed by a plurality of elongated elements, constituted in practice by fibers which are applied by interposing a binding layer 8 and conveniently have a length ranging substantially from 3 to 3000 μm and a diameter comprised substantially in the range 3-1000 μm.

In particular, the binding layer 8 is constituted advantageously by an adhesive material that is at least partially permeable to gases and more precisely to the gaseous phase of sublimating inks.

This characteristic in fact allows the molecules of the ink to pass through the binding layer 8 during the high-temperature transfer, in order to be deposited on the surface of the object 4 to be decorated.

Experimental tests have shown that the best results are achieved by using, for the provision of the binding layer 8, adhesive materials such as for example nitrocellulose or other nitrosynthetic binding agents in general.

Advantageously, the fibers of the active layer 5 are constituted by micronized fibers, which are conveniently made of materials whose properties of resistance to thermal and mechanical stresses are substantially constant within the temperature range used during ink transfer.

Preferably, the elongated elements of the active layer 5 are formed by a layer of flocked material, which is constituted by fibers made of Rayon or of other suitable synthetic or natural material, which are advantageously arranged so that their axis is oriented substantially at right angles to the backing layer 2.

The resulting flocked layer in practice allows to form, between the backing layer 2 and the body that is designed to receive the image, a plurality of small air drainage channels, which are connected to each other and to the outside and allow to perform, during the step in which vacuum is produced, the complete drainage of the air, with transmission of the degree of vacuum on the entire surface to be treated, so as to achieve perfect contact between the sheet-like medium 1 and the body to be decorated, consequently achieving a high print quality.

According to an important embodiment of the invention, shown in FIG. 2, the active layer 5 can comprise, as a replacement of the fibers or in combination therewith, also a plurality of granular elements 9, which can be made of different materials and can be constituted for example by substantially spheroidal bodies, which have a diameter that is substantially uniform and preferably ranging substantially from 3 to 100 μm and more preferably from 5 to 30 μm.

Merely by way of example, the granular elements 9 can be constituted by silicates or organic substances in granular form. In one embodiment, the granular elements 9 can be made of the same materials that can be used for the backing layer 2 and in particular for the film 3.

Advantageously, the granular elements 9 can also be applied by interposing the binding layer 8 and can conveniently be deposited on the binding layer 8 either by means of flocking operations, so as to achieve their arrangement according to a predefined distribution or by way of traditional printing or spreading techniques.

It should be noted that in this case also, the arrangement of the granular elements 9 on the active layer 5 allows to form between the granular elements 9 a plurality of mutually connected channels which facilitate the escape of the air when vacuum is produced, so as to make the sheet-like medium 1 adhere perfectly to the imprintable body.

In practice, with the above described structure of the active layer 5 it is possible to obtain advantageously, on the face of the active layer 5 that is designed to be directed toward the object 4, a surface roughness Ra ranging substantially from 0.1 to 500 μm and more preferably from 0.6 to 6 μm. It has been found that with these values of surface roughness Ra it is possible to ensure optimum transmission of vacuum to all points of the surface of the item 4 to be treated and consequently a perfect adhesion of the sheet-like medium 1 to the surface of said object 4.

Advantageously, the ink layer 6 formed with the sublimating inks can be applied by way of any ordinary printing techniques, such as for example screen printing, direct digital printing on a plotter, rotogravure, film retransfer printing, and others.

From a practical point of view, in particular it has been found that it is preferable to use flexographic rotary machines, since they allow to achieve good image quality and satisfactory speed in the operations for applying the layer 6.

In the practical execution of the sheet-like medium according to the invention, one preferably proceeds initially by printing on one face of the backing layer 2 the layer 6 of sublimating inks, for example by flexographic printing.

The binding layer 8 is then applied to the layer 6 for example by spreading.

At this point it is possible to apply the layer of fibers and/or of granular elements 9 to the outer face of the binding layer 8, for example by means of a flocking method, preferably such as the one disclosed in patent no. 1,314,414 by the same Applicant, to which reference is made for the sake of completeness, in which the fibers and/or granular elements 9, charged electrostatically, are deposited owing to the action of an interposed electrical field whose lines of force are oriented at right angles to the backing layer 2.

Thanks to the flocking method, as provided in the patent cited above, it is possible, in particular, to apply the fibers so that they are arranged substantially at right angles to the backing layer 2 and with a density that can vary as a function of the intensity of the electrical field, thus giving the active layer 5 a substantially brush-like structure.

Once these operations have been performed, the sheet-like medium 1 is obtained, which can be used as a transfer medium for sublimation transfer of images onto an imprintable body.

It should be noted that according to a possible constructive variation, the granular elements 9 or the elongated elements can be applied directly to the backing layer 2 without the interposition of the binding layer 8, by using granular elements 9 or elongated elements that are capable of self-sticking to the backing layer 2, for example because they are themselves coated with adhesive material, or by providing the joining by thermal bonding (which can be achieved by heating) of the granular elements 9 or of the elongated elements to the backing layer 2.

It should also be added that the sheet-like medium 1 thus obtained can be used to provide bags or pouches, in which it is possible to arrange the object 4 to be treated, so as to obtain the decoration on all of its surfaces.

In this regard, it is noted that if the granular elements 9 are provided by using the same material used for the film 3 of the backing layer 2, two portions of the sheet-like medium 1 can be easily heat-sealed together so as to allow for example to obtain closed bags.

In the practical use of the invention, in order to transfer images by ink sublimation, the sheet-like medium 1 is applied to the imprintable surface of the object 4 to be decorated and the interspace provided between the sheet-like medium 1 and the imprintable surface is connected to an air suction pump, so as to produce vacuum in the interspace and consequently achieve perfect contact between the sheet-like medium 1 and the imprintable surface.

Advantageously, by acting by means of an air suction pump it is possible to bring the pressure inside the interspace to a minimum value of −75 cmHg.

Once these operations have been performed, the process for sublimation of the inks of the layer 6 is started by raising the temperature to the sublimation threshold, which can range from 120 to 220° C.

At this point, the inks in the gaseous phase penetrate the active layer 5 until they reach and wet the surface of the imprintable or receiving material.

It should be noted that during the sublimation of the inks it is conveniently possible to provide for constant vacuum condition, by means of the pump, in the interspace between the sheet-like medium 1 and the receiving surface also due to the presence of the small connecting channels formed between the fibers and/or the granular elements 9 of the active layer 5.

From what has been described above it is therefore evident that the invention achieves the intended aim and objects, and in particular the fact is stressed that a sheet-like medium for providing processes for transferring images with sublimating inks is provided which is capable of adapting in an optimum manner to the various shapes of the surface of the imprintable or receiving object, allowing transfer of the image with high accuracy and quality.

Moreover, thanks to its particular structure, the sheet-like transfer medium according to the invention allows to keep substantially unchanged the degree of definition of the image, both in terms of intensity of the colors and in terms of graphic resolution (dpi) and without having the defects that used to be observed in the background art, by applying the sublimating inks to the face of the sheet-like medium provided with the microfibers.

All the characteristics of the invention described above as advantageous, convenient or the like may also be omitted or be replaced with equivalents.

The individual characteristics described with reference to general teachings or to particular embodiments may all be present in other embodiments or may replace characteristics in these embodiments.

The invention thus conceived is susceptible of numerous modifications and variations, all of which are within the scope of the appended claims.

All the details may furthermore be replaced with other technically equivalent elements.

In practice, the materials used, so long as they are compatible with the specific use, as well as the contingent shapes and dimensions, may be any according to requirements.

The disclosures in Italian Patent Application No. VR2005A000095 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

What is claimed is:

1-10. (canceled)

11. A sheet-like transfer medium for transferring images with sublimating inks, comprising a backing layer and an active layer, said active layer being provided so as to face an object to be treated and being adapted to form a plurality of air drainage channels in order to allow to maintain, in an interspace between the sheet-like medium and the object to be treated, a substantially uniform pressure which is lower than a pressure that acts on an outer side of the sheet-like medium, at least one layer comprising sublimating inks being interposed between said backing layer and said active layer, said active layer being at least partially permeable to the gaseous phase of said sublimating inks.

12. The sheet-like transfer medium according to claim 11, wherein said backing layer is substantially impermeable to sublimating inks in the gaseous phase.

13. The sheet-like transfer medium according to claim 11, wherein said backing layer comprises a film made of thermoplastic material.

14. The sheet-like transfer medium according to claim 11, wherein said backing layer is made of substantially rigid material.

15. The sheet-like transfer medium according to claim 11, wherein said backing layer comprises a sheet-like element made of paper-like material or a film made of biaxially-oriented polyester.

16. The sheet-like transfer medium according to claim 11, wherein said active layer comprises a plurality of elongated elements and/or of granular elements applied by way of a binding layer.

17. The sheet-like transfer medium according to claim 16, wherein said binding layer is made of an adhesive material that is at least partially permeable to the gaseous phase of sublimating inks.

18. The sheet-like transfer medium according to claim 16, wherein said elongated elements are oriented substantially at right angles to said backing layer.

19. The sheet-like transfer medium according to claim 16, wherein said granular elements are made of the same material as said film.

20. The sheet-like transfer medium according to claim 11, wherein said active layer has a surface roughness Ra ranging substantially from 0.1 to 500 μm and more preferably from 0.6 to 6 μm.
